(19) United States
(12) Patent Application Publication
(10) Pub. No.: US 2021/0287315 A1
(43) Pub. Date: Sep. 16, 2021

(54) ARCHITECTURES AND METHODS FOR GENERATING AND TRANSFERRING ELECTRONICALLY SIGNED DOCUMENT DATA PACKAGES

(71) Applicant: HANTZ GROUP, INC., Southfield, MI (US)

(72) Inventors: Debbie Dombeck, Shelby Township, MI (US); John Arkins, Birmingham, MI (US); Roy Gelerman, Milford, MI (US)

(21) Appl. No.: 17/136,995

(22) Filed: Dec. 29, 2020

Related U.S. Application Data
(60) Provisional application No. 62/990,263, filed on Mar. 16, 2020.

(51) Int. Cl. G06Q 50/18; G06K 9/00; G06F 21/64; G06F 21/62; G06F 21/31

(52) U.S. Cl. CPC G06Q 50/18; G06K 9/00442; G06F 21/31; G06F 21/6209; G06F 21/64

(57) ABSTRACT

Methods and architectures for transferring electronically signed documents along with associated data are described. The method includes recreating a company 1 activity 1 template for customer 1 and prepopulating it with customer 1 form data for review by a licensed representative (LR). The LR may then make modifications based on customer 1 personal information, upload supporting transaction documents for company 1 and activity 1 and create a packaged activity document that combines the company 1 activity 1 template for customer 1 with the activity 1 supporting transaction documents. The packaged activity document then undergoes a signing and review authorization protocol using an electronic signature service before obtaining a final consent from the customer 1 and storing a bundle of documents including the company 1 activity 1 template, related customer 1 data, electronic signatures, and associated transaction blotter entries, in a database.

### CROSS-REFERENCE TO RELATED APPLICATION

This application claims the benefit of U.S. Provisional Application No. 62/990,263, filed Mar. 16, 2020, which is incorporated herein by reference in its entirety.

### TECHNICAL FIELD

Embodiments relate to methods for transferring electronically signed documents. More particularly, embodiments relate to methods and architectures for generating and transferring electronically signed documents along with associated data.

### BACKGROUND

Many advanced electronic signature services available in the marketplace enable contracts and other documents to be pre-populated and signed with an industry standard electronic signature process. The output of these electronic signature services is often what is effectively a simple digital representation of the original paper documents they were intended to replace. This kind of electronic signature service by a second party may be suitable for generating and storing electronically signed documents and contracts that stay within the originating party. However, when a pre-populated document is destined for a third party other than the originating party, a separate and potentially costly data transmission process, such as an out of band process, often has be put in place to transfer not only the electronically signed document, but also the data embodied by the electronically signed document.

Some transfer solutions involve manually entering, by the third party, the data from the document into their systems. Other solutions involve attempting to programmatically “scrape” the data from an electronically signed document. As may be appreciated, for every different third-party recipient of an electronically signed document, a different workflow, with different documents and different rules, may be required, based on the data transmission method chosen (out of band, manual data entry, scraping, or other), leading to inefficiencies. Therefore, transmitting electronically signed documents and data between parties is a technical problem that is currently being addressed with various sub-optimal solutions.

Accordingly, improvements in methods and architectures for transferring electronically signed documents and data between parties are desired. The provided embodiments provide a technical solution to this technical problem. Furthermore, other desirable features and characteristics will become apparent from the subsequent detailed description and the appended claims, taken in conjunction with the accompanying drawings and the foregoing technical field and background.

### SUMMARY

Provided is a method for generating electronically signed document data packages. The method includes: at a processor programmed with programming instructions, displaying a graphical user interface (GUI) to a user; receiving from the user, responsive to the GUI, customer 1 form data and an activity 1; recreating a company 1 activity 1 template for customer 1 and prepopulating it with the customer 1 form data; displaying, to the user, the company 1 activity 1 template for customer 1; modifying at least one item on the company 1 activity 1 template for customer 1; uploading supporting transaction documents for company 1 and activity 1; creating a packaged activity document that combines the company 1 activity 1 template for customer 1 with the activity 1 supporting transaction documents; obtaining customer 1 approval of the packaged activity document using an electronic signature service; determining that requirements for a signing and review authorization protocol have been completed; obtaining a final consent from the customer 1; and storing bundle of documents including the company 1 activity 1 template, related customer 1 data, electronic signatures, and associated transaction blotter entries, in a database.

In another embodiment, a system for generating electronically signed document data packages is provided. The system includes: a data storage of customer 1 personal information; a processor operationally coupled to the data storage and configured by programming instructions on non-transient computer readable media to: display a graphical user interface (GUI) to a user; receive from the user, responsive to the GUI, customer 1 form data and an activity 1; recreate a company 1 activity 1 template for customer 1 and prepopulate it with the customer 1 form data; display, to the user, the company 1 activity 1 template for customer 1; modify at least one item on the company 1 activity 1 template for customer 1; upload supporting transaction documents for company 1 and activity 1; create a packaged activity document that combines the company 1 activity 1 template for customer 1 with the activity 1 supporting transaction documents; obtain customer 1 approval of the packaged activity document using an electronic signature service; determine that requirements for a signing and review authorization protocol have been completed; obtain a final consent from the customer 1; and store bundle of documents including the company 1 activity 1 template, related customer 1 data, electronic signatures, and associated transaction blotter entries, in a database.

In another embodiment, a computing system for generating electronically signed document data packages is provided. The computing system includes a processor and a data storage having computer-executable instructions stored thereon that, when executed by the processor, cause the computing system to: confirm that a user has successfully passed an authentication process; display a graphical user interface (GUI) to a user; receive from the user, responsive to the GUI, customer 1 form data and an activity 1; recreate a company 1 activity 1 template for customer 1 and prepopulate it with retrieved customer 1 form data; display, to the user, the company 1 activity 1 template for customer 1; modify at least one item on the company 1 activity 1 template for customer 1 based on customer input provided by the user; upload supporting transaction documents for company 1 and activity 1; create a packaged activity document that combines the company 1 activity 1 template for customer 1 with the activity 1 supporting transaction documents; obtain customer 1 approval of the packaged activity document using an electronic signature service; reference a signing and review authorization protocol for the activity document; determine that requirements for the signing and review authorization protocol have been completed; obtain a final consent from the customer 1; and store bundle of documents including the company 1 activity 1 template, related customer 1 data, electronic signatures, and associated transaction blotter entries, in a database.

### BRIEF DESCRIPTION OF THE DRAWINGS

A more complete understanding of the subject matter may be derived by referring to the detailed description and claims in conjunction with the following figures, wherein like reference numbers refer to similar elements throughout the figures.

FIGS. 1-2 depict a method for generating electronically signed document data packages, in accordance with various embodiments;

FIGS. 3-4 illustrate some pages of a graphical user interface for a system for generating electronically signed document data packages, in accordance with various embodiments;

FIG. 5 is a block diagram representation of an exemplary environment in which the system for generating electronically signed document data packages might be used;

FIG. 6 is a block diagram representation of another exemplary environment in which the system for generating electronically signed document data packages might be used; and

FIG. 7 is another illustration of a page of a user interface for a system for generating electronically signed document data packages, in accordance with various embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

In the following description, numerous specific details are set forth. However, embodiments of the invention may be practiced without these specific details. In other instances, well-known structures and techniques have not been shown in detail in order to avoid obscuring the understanding of this description.

As mentioned, when a pre-populated document is destined for a third party other than the originating party, a separate, potentially costly, and sub-optimal data transmission process, such as an out of band process, often has be put in place to transfer not only the electronically signed document, but also the data embodied by the electronically signed document. Other available sub-optimal solutions include manually entering, by the third party, the data from the document into their systems, and attempting to programmatically “scrape” the data from an electronically signed document. Therefore, transmitting electronically signed documents and data between parties is a technical problem that is currently being addressed with various sub-optimal solutions.

Various embodiments described herein provide technical solutions to these problems. The provided techniques and architectures utilize and optimize a novel algorithm that efficiently and effectively recreates the originating party's (referred to as company 1) document (referred to herein as an activity template) and associated application. The provided techniques and architectures may also receive, from a customer relationship management (CRM) system, the personal data for a customer related to the activity template of company 1. The provided techniques and architectures enable modifications to the activity template of the customer (e.g., the customer document) and flexibly support a variety of electronic signature and review protocols prior to generation of an output, which is an electronically signed document data package including a customer document and associated data for company 1. The provided embodiments further flexibly support: a plurality of companies; for each of the plurality of companies, multiple different activity templates; and a different plurality of customers.

One or more embodiments allow a registered licensed representative (LR) to use a uniform graphical user interface (GUI) instead of multiple discrete software applications and with different digital user interfaces to enter data, perform workflow processing, validate data entry and guide a customer through a process to create an accurate and compliant application that is digitally transmitted with an electronic signature to a product company. One or more embodiments of the invention uses a novel algorithm to create a product company agnostic workflow to simplify the entry of data by disassembling a product company application and reassembling it inside of the system so that it follows the familiar workflow. All product company applications in the system are fed by a database of client information which allows a single object representing a client's (e.g., customer 1) information (e.g., personal information or form data) to feed multiple product company applications/systems (e.g., company 1, company 2, etc.). The data may also be transferred via an application programming interface (API) or file to third party applications, so that many representations of the customer 1 are fed by a single source of truth. At different points in the workflow, forms and documents can be added and captured in a data package referred to herein as a packaged activity document. The provided embodiments are described in more detail below.

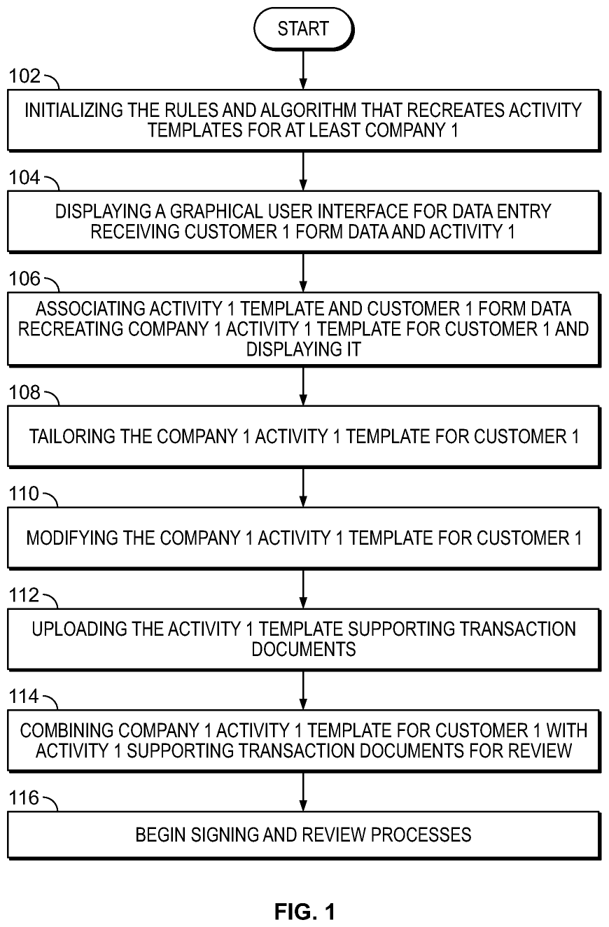

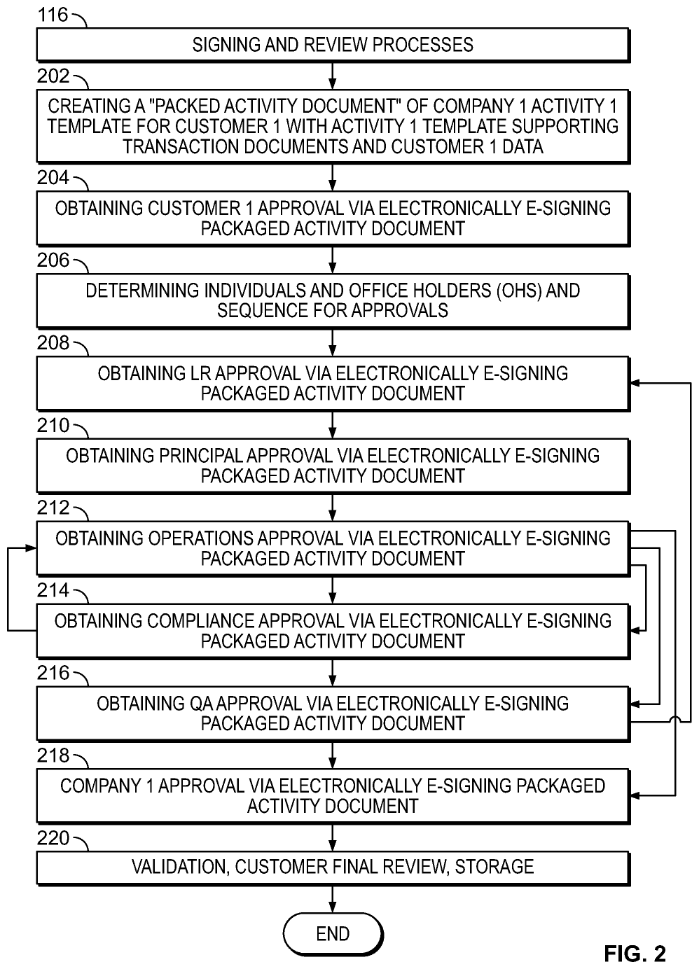

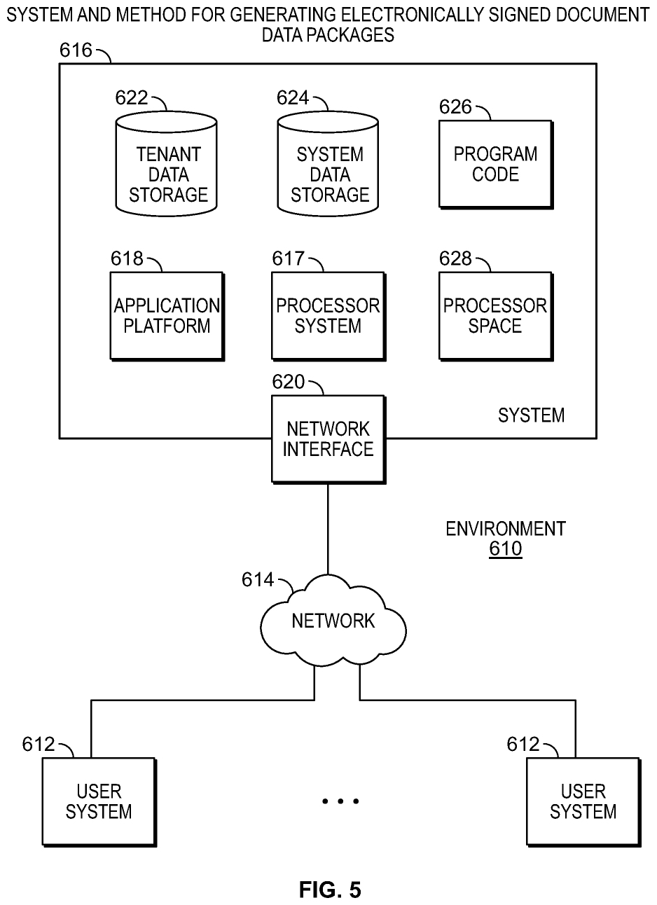

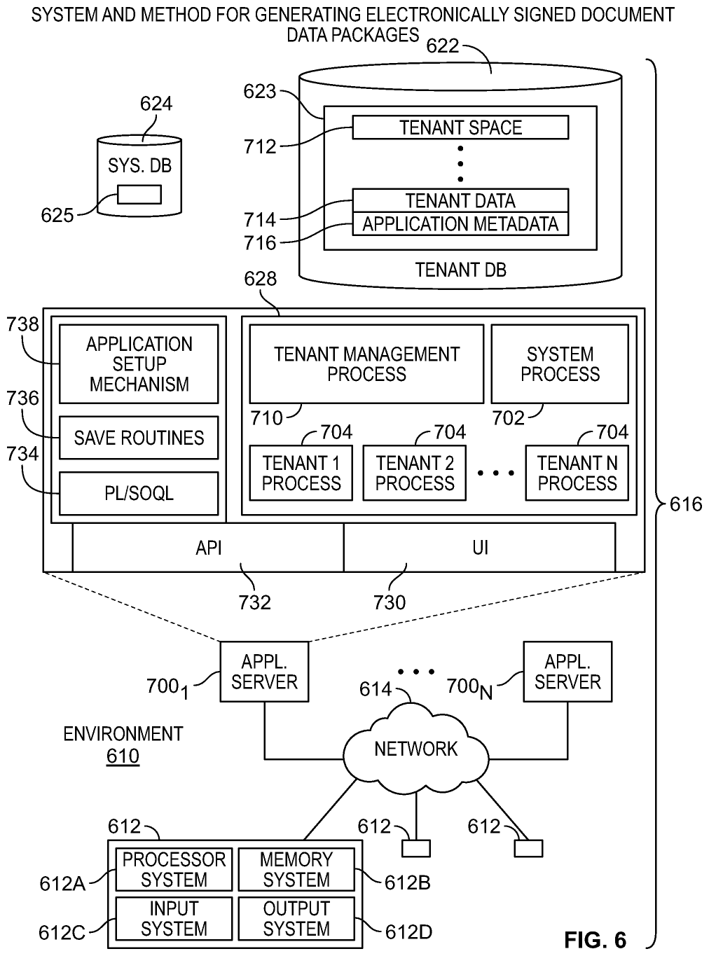

FIGS. 1-2 depict a method 100 for generating electronically signed document data packages by process steps or architectures (for example, FIG. 5 and FIG. 6, system 616). In various embodiments, a processor (FIG. 6, 617) of the system 616 may be initially initialized (at 102) or programmed with the novel algorithm that embodies rules (e.g., FIG. 5 program code 626), and thereforth, the system 616 performs the functions and operations described herein for recreating at least a company 1 activity 1 template. Company 1 may be any client-company for which the system 616 has been configured to operate. In an example, company 1 is Nationwide. Non-limiting examples of activity templates include an annuity or Life insurance template, an Investment Advisory and a Broker Dealer transaction template, and a Securities transaction template. As may be appreciated, company 1 may have more than one activity template, each directed to a different transaction (in an embodiment, company 1 offers an Annuity template and a Securities Transaction template). Additionally, in practice, company 1 may be one of a plurality of companies, and the algorithm loaded at 102 may include rules to direct a processor 617 or system 616 to recreate respective activity templates for each of the plurality of companies.

Initialization at 102 may include uploading the algorithm into memory integrated with the processor 617 or uploading the algorithm into a separate memory device that the processor 617 executes to perform the method steps described herein. Accordingly, any of the herein described functions may be attributed equally to the system 616 and to the processor 617, as the processor 617 may direct the function of the system 616.

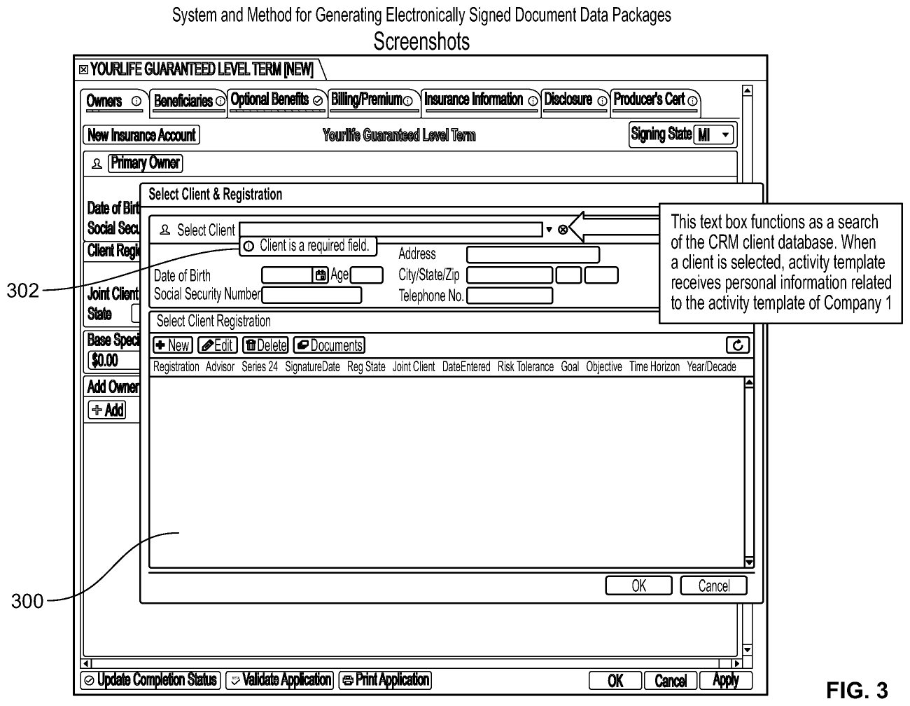

In various embodiments, at 104, responsive to a prompt by a licensed representative (LR), the system 616 may generate and display a user interface page (for example, FIG. 6, 730) for the LR to view and to prompt the LR to enter data. In various embodiments, the user at 104 is a licensed representative (LR) and may have successfully passed an authentication process in order to provide input or to perform step 104. In various embodiments, the system 616 may display an initial display screen with a graphical user interface (GUI) page having thereon at least a dialogue box for selecting a customer (see, for example, FIG. 3, 300 and dialogue box 302). This dialogue box may serve as a search of the CRM database for the customer. In various embodiments, the GUI also has a selection box for selecting an activity.

In another example, the user interface page may prompt the user to enter a customer name and activity, and then may search a customer database to obtain customer personal data therefrom. In another example, the user interface page may prompt the user to enter a customer name, customer personal information, and activity (for example, customer 1 name, activity 1, and customer 1 personal information and data related to an activity 1 template for the company 1

At 104, the processor 617 may receive, responsive to the GUI page, from a user at an input system (e.g., FIG. 6, 612C), or customer relationship management (CRM) system, the customer 1 name and an activity 1. In other embodiments, at 104, the processor 617 may receive, responsive to the GUI page, customer 1 name, an activity 1 and customer 1 form data, which is the aforementioned customer 1 personal information and data related to an activity 1 to be used to fill out an activity 1 template for company 1.

The combination of input at 104 may be viewed as a transaction prompt to the system 616 to retrieve the customer 1 form data and associate it with an activity 1. In a non-limiting example, a transaction prompt includes: {customer:activity:company}, such as, {Jones:Life Insurance:Nationwide}.

At 106, the processor 617 receives the transaction prompt, processes it with its stored rules, and recreates a company 1 activity 1 template therefrom. The processor 617 further prepopulates the company 1 activity 1 template with at least some of the received customer 1 personal information and data. At 106 the recreation of the company 1 activity 1 document, prepopulated for customer 1, may be presented a display on a user system 612 (such as an output system 612D), so that the LR may view it. Often, at this step, the LR views it with the customer 1 present, but this is not a requirement. Upon viewing the company 1 activity 1 document, prepopulated for customer 1, the LR may (at 108) respond by tailoring it, i.e., providing further inputs to tailor it to customer 1, such as filling in specific details for the transaction, and/or making customer 1-specific edits and requests. In various embodiments, the system may prompt the LR to perform the tailoring step and may prompt the LR to confirm when the tailoring step is complete. As with the other LR inputs described herein, the tailoring inputs may be provided to the system 616 by the LR at user system 612 on input system 612C, for example.

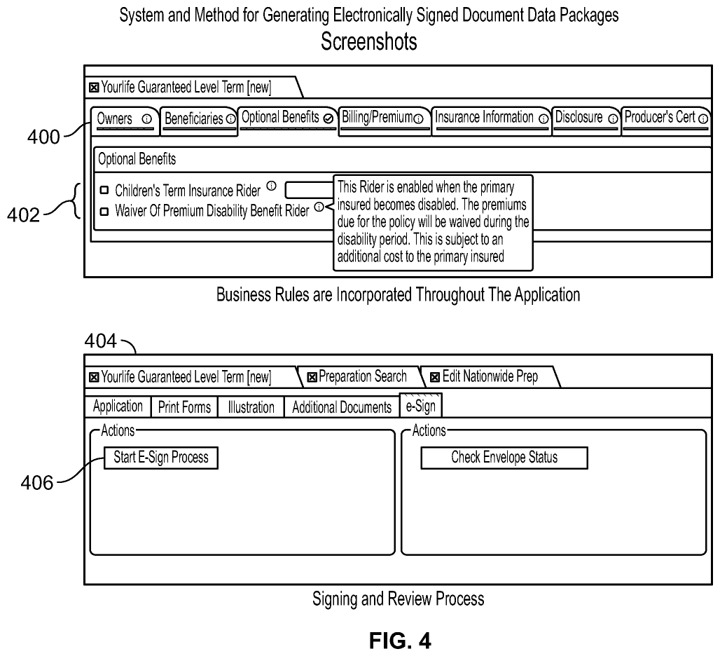

At 110, the processor 617 modifies at least one item on the company 1 activity 1 template for customer 1 responsive to inputs received from the customer 1 via the LR at 108. At 112, the processor 617 may upload supporting transaction documentation (FIG. 4, 400) that is specific to the company 1 activity 1 document, prepopulated for customer 1. Non-limiting examples of supporting documentation includes riders (FIG. 4, 402) waivers, specifications, legally mandated disclosures, and the like. In various embodiments, at 112, the system 616 prompts the LR to upload the supporting documents. In other embodiments, at 112, the system 616 automatically uploads the supporting documents, based on the rules in the algorithm and company 1 specifications stored in a database 622. At 114 the system 616 combines the company 1 activity 1 template for customer 1 with activity 1 template supporting transaction documents for review.

The output at the completion of 114 (the document modified company 1 activity 1 document, prepopulated for customer 1, including supporting documentation) may generally be referred to as an “activity document” (and in a specific example, it is referred to as a customer 1 activity 1 document). At 114, the activity document may be displayed (such as an output system 612D) on a user system 612, so that the LR may view it. After 114, the activity document is ready for the signing and review processes, indicated generally at 114 and described in more detail in connection with FIG. 2.

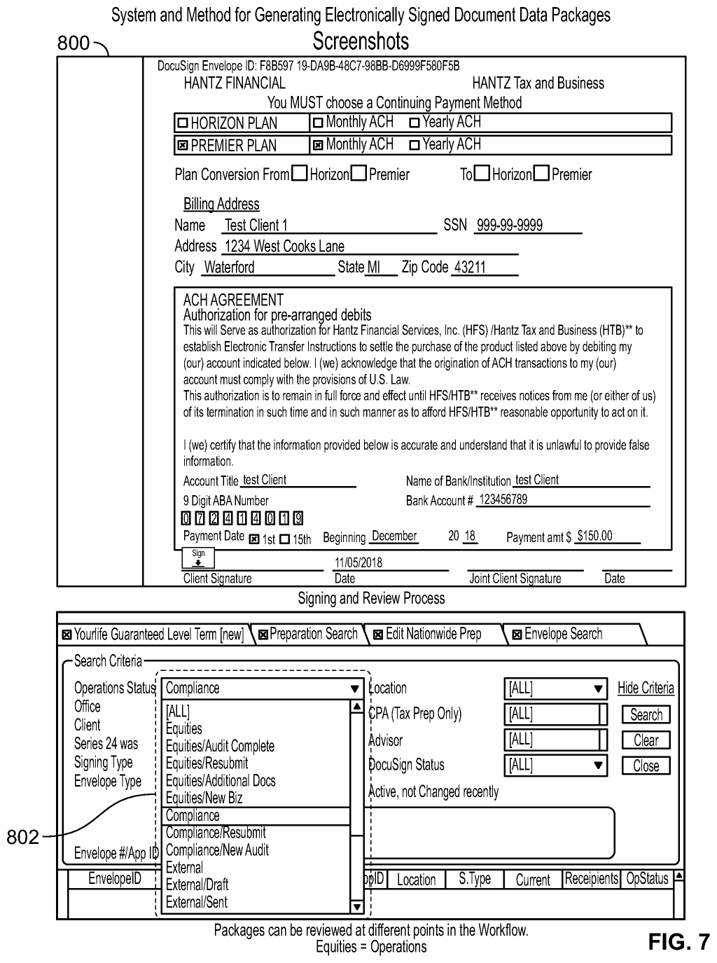

With reference to FIG. 2, the signing and review processes 114 are described. The signing and review processes may include multiple steps, each step of the multiple steps receiving a first document and outputting a second document; and, in each step of the multiple steps, the output second document has been approved by at least one required approver, and the output second document may include a revision to or modification of the received first document. At 202, the system 616 provides a GUI page to begin the e-signing process (FIG. 4, 404). Responsive to user input (FIG. 4, 406) in connection with the page 404, a “packaged activity document” (e.g., customer 1 activity 1 document) is created using a commercially available e-signing software tool for electronic signing. As used herein, the “packaged activity document” is a bundle that includes the company 1 activity 1 template for customer 1 with activity 1 template supporting transaction documents and the customer 1 data. A header page for the LR may be placed at the beginning of the activity document (FIG. 7, 800).

At 204, customer 1 approval is obtained, as determined by receiving one or more customer 1 electronic signatures for the packaged activity document.

At 206, the processor 617 references a signing and review authorization protocol for the specific activity template to determine requirements for a signing and review, the signing and review authorization protocol includes (i) multiple individuals, agents, or office holders (OHs), and (ii) a sequence of the individuals, agents, or OHs for which approvals are required. In various embodiments, at 206, a pre-programmed signing and review authorization protocol is referenced. In other embodiments, at 206, the user or LR is prompted with a GUI interface to select the signing and review authorization protocol (e.g., FIG. 7, 802).

The example provided with steps 204-216 shown below is understood to be an example embodiment; a variety of different signing and review authorization protocols may be used. Each signing and review authorization protocol may reflect the customer, the company, and/or the activity. Each signing and review authorization protocol may reflect a management structure for the user or LR. In an example, the individuals and OHs include at least one OH, and a company 1 representative. In some embodiments, after one OH approves, the packaged activity document may be sent to more than one other individual or OH in parallel, such as is indicated in FIG. 2 212, with the output from Operations going to Compliance, QA, and Company 1 at the same time.

In an embodiment, the signing and review individuals/agents/OHs and respective sequence may be set up in the system 616 like a state-machine, in which the document and associated customer 1 form data do not move from a first stage to a second stage until the respective required approver has approved the document. This is illustrated in FIG. 7, wherein a sequence for review includes individuals, agents and/or group representatives may be pre-selected (for example by prompting a user to supply this input via a pull-down menu 802). In various embodiments, an algorithm in the novel program checks for licensing requirements related to the activity template, and creates the sequence of individuals, agents and/or group representatives for review based on the licensing requirements of the activity template; in these embodiments, the algorithm includes rules for checking the licensing requirements. The processor 617 tracks and sends the packaged activity document between individuals and OHs in accordance with the signing and review authorization protocol until the signing and review authorization protocol is completed. For example, following the above example, the processor 617 determines that requirements for the signing and review authorization protocol have been completed upon determining that the electronic signatures of the LR, the at least one OH, and the company 1 representative have been obtained in the right sequence (i.e., in accordance with the predefined sequence).

At 208, the processor 617 obtains LR approval, as determined by receiving one or more LR electronic signatures for the packaged activity document. At 210, approval from a Principal is obtained, as determined by receiving one or more OR electronic signatures for the packaged activity document. At 212, an Operations Representative (OR) is obtained, as determined by receiving one or more OR electronic signatures for the packaged activity document. After 212, the packaged activity document may be sent to compliance at 214 for approval, to Quality Assurance (QA) for approval at 216, and/or to company 1 for approval at 218.

In various embodiments, an individual or office holder (OH) may make a modification or request that additional details be provided. The request may be directed to the customer, LR, or to another individual, agent, or OH in the predefined sequence; as shown in FIG. 2, this may lead to cycling the packaged activity document back to the LR for approval at 208, to the customer at 204, and/or to any of the individuals, agents, or office holders.

At 220, after determining that the requirements of the signing and review authorization protocol have been completed, and receiving, from Company 1, the packaged activity document and an indication that company 1 (i.e., an appropriate representative from company 1) has approved the packaged activity document, the packaged activity document (e.g., a life insurance policy for Jones) is deemed validated by the system 616. Responsive to determining that the packaged activity document is validated at 220, the system may prompt the user or LR to obtain a final electronic signature or a written signature from the client that indicates the client's final consent. At 220, responsive to obtaining a final consent, in the form of a final electronic signature or a written signature from the client that indicates the client's final consent, the system may capture, bundle, and store all completed documents and associated transaction blotter entries, including the company 1 activity 1 template plus related customer data, in the database (for example, database 624).

Additionally, in various embodiments, the processor 617 may access a storage device (for example, database 110, tenant data storage FIG. 5, 622) containing information for a given tenant or company, such as company 1. The system 616 may utilize the company 1 information to digitally wrap the stored and bundled data in a manner that restricts, via an authentication protocol, use and modification of [customer 1 personal information and data related to the activity 1 template for the company 1] to only licensed representatives (LR).

In various embodiments, as part of the signing and review authorization protocol, the system may generate a product company-specific API (e.g., company 1-specific) for the user (e.g., the LR or any of the individuals and OHs) to pass their credentials to the company (e.g., company 1) for verification of their appointment and appropriateness in the sequence. The system may prevent non-verified users to participate in the signing and review process. Non-limiting examples of methods for this to be performed by the system include: generating the product company-specific API by the processor 617; engaging, by the system, a third party license check company; employing, by the system, a DTCC (data transfer agent) to provide a licensing and appointment file to the system that the system references; and, maintaining, by the system, a separate internal licensing system, for example, with an internal compliance or HR department review step.

In summary, it may be appreciated that, in different embodiments, the signing and review process, and in particular, the steps 204-216 may be arranged differently, there may be additional steps, and/or there may be omitted steps. Regardless of the order of steps 204-216, the commercially available electronic signing software (also sometimes referred to as e-signing and docu-signing) is used at each of the steps 204-216 to create a customer document from the activity template (e.g., customer 1 document 1 is representative of the customer 1 activity 1 template). For each stage of the signing and review process, the system 616 creates an electronic package that includes the customer 1 activity 1 document with associated customer 1 form data.

Provided herein is an electronic and digital signature system and method that provides electronic signing on a novel package of data, the data package described herein. In various embodiments, the system 616 will be used to authenticate the identity of each sender and signer of the data package. That data package will be transmitted to the third-party company for account opening or account maintenance. The system will also be used to ensure that the original data package has remained unchanged. The document processing system includes a registration component that programmatically stores the data package encrypted for the amount of time required to satisfy relevant regulators like FINRA and the SEC.

The provided embodiments greatly reduce the storage component of electronically signed documents as only the data specific to a particular transaction are stored. When the data requires human interaction, the data is sent to the activity template that corresponds to the template used on the original paper document. Therefore, the only pdf stored is the blank form that will be used to present the information to a human.

Provided embodiments abstract various applications and related activity templates from the company. This allows the licensed representative to focus on data accuracy instead of the nuances of the forms from different companies and product providers. One or more embodiments allows for straight-through processing by integrating payment processing, processing of multiple forms, electronic signatures, document management and workflow processing.

One or more embodiments performs validations at every stage of processing to ensure the information is sufficient and accurate and is suitable for the customer. This process is compliant with financial regulations. As a benefit, embodiments deliver better “In Good Order” rates because the validation occurs up front and at every stage of the process, instead of at the backend when it is processed by the product company. This advantageously also reduces time to account opening, reduces time required for document processing, increases compliance and allows for easier audits and turnaround times.

The novel algorithm may be implemented as rules in a program (for example, FIG. 5 program code 626). As may be appreciated, the rules were generated to reflect multiple company documents, activity requirements, and fee schedules. When the rules are for Investment Advisory companies and activities, the respective fee schedules can be built into the application or activity template that the LR or other customer interacts with. Fees are a very important part of the compensation of a registered investment advisor (e.g., the LR), and they must be explicitly and unambiguously presented to all parties involved in the transaction. The program code 626 enables companies to build into the software the fee schedule so that it may be printed to an output document and be part of the resulting data package. A company, for example, Charles Schwab, may have a basis point fee schedule that they charge on accounts. There may be breakpoints in the fee schedules, to where the more you invest, the lower your fees will be. Those fees, and any related schedules for them are built into the activity template by the rules in the program code 626. In addition, there may be a second layer of fees, advisory fees, those charged by a Registered Investment Advisor, that can also be built into the rules for each company of a plurality of companies.

Personal form data can include, for example, customer name, date of birth, address, social security number, marital status, children, parents, client accounts, insurance, net worth, debt, and other information used to verify the identity of the customer in an electronic signing process. In addition to the personal information used to verify the identity of the signers, other information can be added into the application, depending on the type of business that is being written. The personal data may be provided via a CRM database, and may have an initial form as a PDF file. The rules engine may digitize the fields of the PDF and create the packaged customer 1 activity document and customer 1 form data by combining the personal information received and digitized with an electronic signature.

The approaches and methodologies presented here can be utilized in various computer-based environments, network environments, application programming interfaces (APIs), and/or database system environments.

APIs can be connected to pull in data in and import data feeds. Depending on the type of application being created, API calls can be made during application creation that build the application. For example, in financial services transactions involving a Broker-Dealer, a distributor of product (Broker-Dealer) has a relationship with Product Company A, a Life Insurance Company, the Broker has a relationship with Product Company A. An account opening process can be connected with the Product Company An API, so that Life Insurance Illustrations can be run directly in the account opening system and the output is attached to the application before being submitted to Product Company A. The illustration can be something that the Broker and Product Company A requires to be attached to every application document submitted for approval review. Without this system, a separate piece of software had to be downloaded to create the illustration. The illustration must be saved as a pdf and stored locally, and then uploaded to the account opening software or printed with a paper application.

FIGS. 3 and 4 are illustrations of a graphical user interface that may be displayed on a user system (FIG. 6, 612) for use by a licensed representative while using for generating electronically signed document data packages by methods or architectures, such as system 616 and interacting on behalf of a customer. In FIG. 3, a search box for the CRM database is depicted. When a client name is entered into the search box, the system 616 populates a selected activity template for a selected company with the client/customer personal information relevant to the activity template. In FIG. 4, selection boxes for optional benefits are depicted. These options, when selected, may trigger the rules to include additional supporting documentation and/or schedules. Another selection box depicts the beginning of a signing and review process. In FIG. 7, additional screenshots depict various embodiments of a signing and review protocol. Different agents and groups may be selected, such as compliance, quality assurance, etc., and they may be assigned an order for completion. When the agents are selected, the signing and review process routes electronically signed data packages to the selected groups in accordance with a prearranged order.

Turning now to FIG. 5, a block diagram of an environment 610 wherein an on-demand CRM database service might be used for purposes of supporting the subject matter described in more detail above. Environment 610 may include user systems 612, network 614, system 616, processor 617, application platform 618, network interface 620, tenant data storage 622, system data storage 624, program code 626, and process space 628. In other embodiments, environment 610 may not have all of the components listed and/or may have other elements instead of, or in addition to, those listed above.

Environment 610 is an environment in which an on-demand database service exists. User system 612 may be any machine or system that is used by a user to access a database user system. For example, any of user systems 612 can be a handheld computing device, a mobile phone, a laptop computer, a workstation, and/or a network of computing devices. As illustrated in herein FIG. 5 (and in more detail in FIG. 6) user systems 612 might interact via a network 614 with an on-demand database service, which includes system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels and authorization protocols) for the current user. For example, where a field technician is using a particular user system 612 to interact with system 616, that user system has the capacities allotted to that field technician. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the Internet, that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 5, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 5, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 5 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices (e.g., a combination of an input system 612C and output system 612D), such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core series processor or the like. Similarly, system 616 (and additional instances of an MTS, where more than one is present) and all of their components might be operator configurable using application(s) including computer code to run using a central processing unit such as processor system 617, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk on user system 612, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), Microdrive, and magneto-optical disks, and magnetic or optical cards, Nano systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java', JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 610. However, in FIG. 6 elements of system 616 and various interconnections in an embodiment are further illustrated. FIG. 6 shows that user system 612 may include processor system 612A, memory system 612B, input system 612C, and output system 612D. FIG. 6 shows network 614 and system 616. FIG. 6 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 7001-700N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 5. Regarding user system 612, processor system 612A may be any combination of one or more processors. Memory system 612B may be any combination of one or more memory devices, short term, and/or long-term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 6, system 616 may include a network interface 620 (of FIG. 5) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle' databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 7001 might be coupled via the network 614 (e.g., the Internet), another application server 700N-1 might be coupled via a direct network link, and another application server 700N might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 BIG-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each field technician uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can use their assigned security protocols to obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method for generating electronically signed document data packages, comprising:
a. at a processor programmed with programming instructions,
displaying a graphical user interface (GUI) to a user;
receiving from the user, responsive to the GUI, customer 1 form data and an activity 1;
recreating a company 1 activity 1 template for customer 1 and prepopulating it with the customer 1 form data;
displaying, to the user, the company 1 activity 1 template for customer 1;
modifying at least one item on the company 1 activity 1 template for customer 1;
uploading supporting transaction documents for company 1 and activity 1;
creating a packaged activity document that combines the company 1 activity 1 template for customer 1 with the activity 1 supporting transaction documents;
obtaining customer 1 approval of the packaged activity document using an electronic signature service;
determining that requirements for a signing and review authorization protocol have been completed;
obtaining a final consent from the customer 1; and
storing bundle of documents including the company 1 activity 1 template, related customer 1 data, electronic signatures, and associated transaction blotter entries, in a database.

2. The method of claim 1, wherein the user is a licensed representative (LR).

3. The method of claim 2, further comprising, performing an authentication step by the processor to authenticate the LR before accepting input from the LR.

4. The method of claim 3, further comprising prompting the LR to receive a customer 1 specific edit to the company 1 activity 1 template for customer 1.

5. The method of claim 4, wherein modifying the at least one item on the company 1 activity 1 template is based on having received the customer 1 specific edit to the company 1 activity 1 template for customer 1.

6. The method of claim 5, wherein the signing and review authorization protocol includes multiple individuals or office holders (OHs), and a sequence of the individuals or OHs for which approvals are required for the activity 1 template.

7. The method of claim 6, wherein the multiple individuals or office holders (OHs) includes the LR, at least one office holder (OH), and a company 1 representative.

8. The method of claim 7, wherein determining that requirements for the signing and review authorization protocol have been completed includes determining that the electronic signatures of the LR, the at least one OH, and the company 1 representative have been obtained in a right sequence.

9. A system for generating electronically signed document data packages, comprising:
a data storage of customer 1 personal information;
a processor operationally coupled to the data storage and configured by programming instructions on non-transient computer readable media to:
display a graphical user interface (GUI) to a user;
receive from the user, responsive to the GUI, customer 1 form data and an activity 1;
recreate a company 1 activity 1 template for customer 1 and prepopulate it with the customer 1 form data;
display, to the user, the company 1 activity 1 template for customer 1;
modify at least one item on the company 1 activity 1 template for customer 1;
upload supporting transaction documents for company 1 and activity 1;
create a packaged activity document that combines the company 1 activity 1 template for customer 1 with the activity 1 supporting transaction documents;
obtain customer 1 approval of the packaged activity document using an electronic signature service;
determine that requirements for a signing and review authorization protocol have been completed;
obtain a final consent from the customer 1; and
store bundle of documents including the company 1 activity 1 template, related customer 1 data, electronic signatures, and associated transaction blotter entries, in a database.

10. The system of claim 9, wherein the user is a licensed representative (LR).

11. The system of claim 10, wherein the processor is further configured to perform an authentication step to authenticate the LR before accepting input from the LR.

12. The system of claim 9, wherein the processor is further configured to prompt the LR to receive a customer 1 specific edit to the company 1 activity 1 template for customer 1.

13. The system of claim 12, wherein the processor is further configured to modify the at least one item on the company 1 activity 1 template based on having received the customer 1 specific edit to the company 1 activity 1 template for customer 1.

14. The system of claim 9, wherein the signing and review authorization protocol includes multiple individuals or office holders (OHs), and a sequence of the individuals or OHs for which approvals are required for the activity 1 template.

15. The system of claim 9, wherein the multiple individuals or office holders (OHs) includes the LR, at least one office holder (OH), and a company 1 representative.

16. The system of claim 15, wherein the processor is further configured to determine that requirements for the signing and review authorization protocol have been completed by determining that the electronic signatures of the LR, the at least one OH, and the company 1 representative have been obtained in a right sequence.

17. A computing system for generating electronically signed document data packages, the computing system comprising a processor and a data storage having computer-executable instructions stored thereon that, when executed by the processor, cause the computing system to:
confirm that a user has successfully passed an authentication process;
display a graphical user interface (GUI) to a user;
receive from the user, responsive to the GUI, customer 1 form data and an activity 1;
recreate a company 1 activity 1 template for customer 1 and prepopulate it with retrieved customer 1 form data;
display, to the user, the company 1 activity 1 template for customer 1;
modify at least one item on the company 1 activity 1 template for customer 1 based on customer input provided by the user;
upload supporting transaction documents for company 1 and activity 1;
create a packaged activity document that combines the company 1 activity 1 template for customer 1 with the activity 1 supporting transaction documents;
obtain customer 1 approval of the packaged activity document using an electronic signature service;
reference a signing and review authorization protocol for the activity document;
determine that requirements for the signing and review authorization protocol have been completed;
obtain a final consent from the customer 1; and
store bundle of documents including the company 1 activity 1 template, related customer 1 data, electronic signatures, and associated transaction blotter entries, in a database.

18. The computer system of claim 17, wherein the user is a licensed representative (LR).

19. The computer system of claim 18, wherein the processor is further configured to prompt the LR to receive a customer 1 specific edit to the company 1 activity 1 template for customer 1.

20. The computer system of claim 19, wherein the processor is further configured to modify the at least one item on the company 1 activity 1 template based on having received the customer 1 specific edit to the company 1 activity 1 template for customer 1.
